(19) United States
(12) Patent Application Publication
(10) Pub. No.: US 2025/0283660 A1
(43) Pub. Date: Sep. 11, 2025

(54) SYSTEM FOR COLLECTING AND REUSING CARBON DIOXIDE BY USING BLUE HYDROGEN PRODUCTION

(71) Applicant: VICTEX CO., LTD., Incheon (KR)

(72) Inventor: Jin Heung CHOI, Uijeongbu-si, Gyeonggi-do (KR)

(73) Assignee: VICTEX CO., LTD., Incheon (KR)

(21) Appl. No.: 18/862,523

(22) PCT Filed: Jan. 27, 2024
(86) PCT No.: PCT/IB2024/050774

§ 371 Date: Nov. 1, 2024

(30) Foreign Application Priority Data
Nov. 29, 2022 (KR) 10-2022-0163309
Nov. 29, 2022 (KR) 10-2022-0163313
Nov. 29, 2022 (KR) 10-2022-0163321
Nov. 29, 2022 (KR) 10-2022-0163335
Nov. 29, 2022 (KR) 10-2022-0163343

(51) Int. Cl. F25J 1/02; C01B 3/34; C01B 32/50

(52) U.S. Cl. CPC F25J 1/02; C01B 3/34; C01B 32/50; C01B 2203/1241

(57) ABSTRACT

The present invention is directed to a system for collecting and reusing carbon dioxide during a blue hydrogen production process. There is provided a modular system for collecting and liquefying CO₂, the modular system including: a blue hydrogen reforming apparatus configured to extract hydrogen and CO₂ based on natural gas; a treatment module connected to the blue hydrogen reforming apparatus, and configured to perform predetermined treatment so that the pressure of the extracted CO₂ is increased and the temperature of the extracted CO₂ is decreased; and a recovery unit configured to store CO₂ liquefied by the treatment module.

### TECHNICAL FIELD

The present invention relates to a system for collecting and reusing carbon dioxide during a blue hydrogen production process.

### BACKGROUND ART

Until recently, the issue regarding the use of eco-friendly energy has been emerging, and it is becoming recognized throughout the industry that the development of alternative energy is inevitable. To this end, a lot of development money is being invested by various organizations in researching energy sources that can replace fossil fuels. Reformed hydrogen is attracting attention as alternative energy and the energy produced from fossil fuels such as natural gas and LPG. Reformed hydrogen, which is attracting attention as an energy source for various uses such as vehicles, is also called blue hydrogen, and a large amount of carbon dioxide is generated during the process of extracting hydrogen. One of the disadvantages of blue hydrogen extracted from fossil fuels is the generation of a large amount of carbon dioxide. As is already well known, when carbon dioxide is released into the atmosphere, it causes an increase in atmospheric temperature and changes in the marine environment. Accordingly, until an energy source that can completely replace fossil fuels appears, the direct use of fossil fuels and the use of hydrogen, which is energy extracted from fossil fuels, are inevitable. As for a large amount of carbon dioxide expected to be generated in the process of extracting hydrogen from natural gas, there is a demand for a system that collects and reuses carbon dioxide, thereby allowing carbon dioxide to be beneficially used in industrial sites without releasing it into the air.

### DISCLOSURE

### Technical Problem

An embodiment of the present invention may provide a system for collecting and reusing carbon dioxide during a blue hydrogen production process which recovers CO₂ generated in the process of reforming and extracting blue hydrogen, thereby enabling the reuse of CO₂ without releasing CO₂ into the atmosphere.

An embodiment of the present invention may provide a system for collecting and reusing carbon dioxide during a blue hydrogen production process in which the system having a simplified scale requires a small physical space.

### Technical Solution

There is provided a modular system for collecting and liquefying CO₂, the modular system including: a blue hydrogen reforming apparatus configured to extract hydrogen and CO₂ based on natural gas; a treatment module connected to the blue hydrogen reforming apparatus, and configured to perform predetermined treatment so that the pressure of the extracted CO₂ is increased and the temperature of the extracted CO₂ is decreased; and a recovery unit configured to store CO₂ liquefied by the treatment module.

Additionally, the treatment module may perform the decreasing of the temperature through at least a plate heat exchanger.

Furthermore, the treatment module may be connected to a suction line accumulator configured to promote cooling.

Furthermore, in the treatment module, at least one of coolers configured to perform the decreasing of the temperature may perform cooling through an air cooling-type scheme.

Furthermore, the treatment module may perform the increasing of the pressure and the decreasing of the temperature through a plurality of stages.

Furthermore, the treatment module may be connected to be selectively separable from the blue hydrogen reforming apparatus and the recovery unit.

Furthermore, the treatment module may be located between the blue hydrogen reforming apparatus and the recovery unit and include primary and secondary treatment modules configured such that CO₂ sequentially passes therethrough, the primary treatment module may include a first compressor, a first-first cooler, a first separation unit and a first-second cooler through which CO₂ sequentially moves, and the secondary treatment module may include a second compressor, a second-first cooler, one or more second separation units and a second-second cooler through which CO₂ sequentially moves.

Furthermore, the blue hydrogen reforming apparatus may include a chamber configured to maintain internal pressure above atmospheric pressure and store CO₂, and the chamber may include a valve configured to be opened only in one direction, which is a direction in which CO₂ flows in, on one side and to be selectively opened in a direction in which CO₂ is provided to the treatment module on the other side.

Furthermore, the modular system may further include a refrigerant drive unit configured to provide a refrigerant to exchange heat with the first-second cooler and the second-second cooler, and the refrigerant drive unit may provide the refrigerant so that the refrigerant sequentially passes through the second-second cooler and the first-second cooler and cools the refrigerant when it is re-introduced.

Furthermore, the modular system may further include: a distribution unit configured to transfer CO₂, introduced in a gaseous state out of CO₂ stored in the recovery unit, to one of the first and second treatment modules; and a sensor unit located in the extension section of the distribution unit, and configured to guide CO₂ so that CO₂ can be transferred to one of the first and second treatment modules through comparison between the sensing information obtained by detecting the temperature and pressure of CO₂ in a gaseous state and predetermined sensing information.

Furthermore, at least part of the CO₂ liquefied and stored in the recovery unit may be supplied to one or more of the primary and secondary treatment modules and be cooled by heat exchange with the CO₂ in the gaseous state, and may be provided to the refrigerant drive unit and cool the refrigerant.

### Advantageous Effects

According to an embodiment of the present invention, an object is to recover CO₂ generated in the process of reforming and extracting blue hydrogen, thereby enabling the reuse of CO₂ without releasing CO₂ into the atmosphere.

An object of an embodiment of the present invention is for the system having a simplified scale to require a small physical space.

### DESCRIPTION OF DRAWINGS

FIG. 1 is a schematic diagram showing a process of producing blue hydrogen according to an embodiment of the present invention.

FIG. 2 is a diagram schematically showing a treatment module according to an embodiment of the present invention.

FIG. 3 is a diagram illustrating in more detail the movement of CO₂ in a treatment module according to an embodiment of the present invention.

### BEST MODE FOR INVENTION

Hereinafter, specific embodiments of the present invention will be described with reference to the drawings. However, these are only examples and the present invention is not limited thereto.

In the description of the present invention, when it is determined that a detailed description of a known technology related to the present invention may unnecessarily obscure the gist of the present invention, the detailed description will be omitted. Furthermore, the terms to be described below are the terms defined by taking into consideration the functions thereof in the present invention, and may vary depending on the intention of a user or operator, custom, or the like. Accordingly, the definitions thereof should be made based on the context throughout the present specification.

The technical spirit of the present invention is determined by the claims, and the following embodiments are merely means for efficiently describing the technical spirit of the present invention to those having ordinary skill in the art to which the present invention pertains.

One of the purposes of a modular system 10, which is an embodiment of the present invention to be described below, is the recovery of CO₂ that is generated in the process of extracting blue hydrogen. In this case, CO₂ is generated as a by-product in the process of obtaining hydrogen 3 through separation from natural gas 1 using oxygen 2. When CO₂ generated in this case is released into the atmosphere, it acts as a decisive factor in environmental pollution, so that it can be collected and treated. Normally, CO₂ generated in large quantities in the above process is recovered and buried in the seafloor or released into the atmosphere. However, through the present invention, CO₂ generated in a gaseous state may be liquefied and recovered such that it can be used in industrial sites. This has the advantage of eliminating the need to produce separate CO₂ by applying it to CO₂ that must inevitably be used in industrial sites for the purpose of cleaning semiconductors or for other purposes. To this end, the basic mechanism of the present invention is to recover CO₂ in a liquefied state by collecting CO₂ generated when hydrogen 3 is produced from natural gas 1 and exposing it to an environment where conditions such as pressure and temperature are satisfied. In the process of recovering CO₂, it may flow according to the configuration included in the present invention, which will be described in detail below.

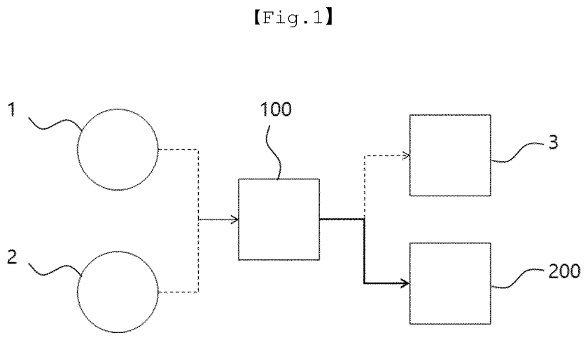

FIG. 1 is a schematic diagram showing the CO₂ reuse system 10 of the present invention.

Referring to FIG. 1, in order for CO₂ to be recovered from natural gas 1, natural gas 1 together with oxygen 2 is supplied to a blue hydrogen reforming apparatus 100, and hydrogen 3 may be separated and extracted from the natural gas 1 inside the blue hydrogen reforming apparatus 100. In this case, CO₂ may be generated during the process of extracting hydrogen 3, and CO₂ may flow into a treatment module 200. For example, the generated CO₂ may be moved to a separate chamber 11 and accumulated within the blue hydrogen reforming apparatus 100, or may be moved to the treatment module 200 immediately after the generation thereof. This may be intended to classify hydrogen 3 and carbon dioxide through a physical factor such as a difference in gaseous density, or may be intended to classify and collect them through a chemical means. The hydrogen 3 and the classified CO₂ may be moved to the chamber 11 provided in the blue hydrogen reforming apparatus 100, and accumulated CO₂ may be transferred to the treatment module 200. In this case, the treatment module 200 connected to the chamber 11 may allow gaseous CO₂ to flow in.

CO₂ introduced into the treatment module 200 may be liquefied through at least one predetermined treatment process. When CO₂ is liquefied through the treatment module 200, CO₂ having passed through the treatment module 200 may be stored in a recovery unit 230. Preferably, CO₂ stored in the recovery unit 230 may be in a liquid state. When some gaseous CO₂ together with liquid CO₂ is introduced, it may be re-introduced into the treatment module 200, etc. for the purpose of re-cooling within the recovery unit 230. This will be described in more detail below.

The recovery unit 230 may be connected to the chamber 11 provided in the blue hydrogen reforming apparatus 100 and having recovered CO₂ through a connection means. The connection means may include a valve. For example, the valve may be opened to the flow of CO₂ flowing into the chamber 11, but may be selectively opened to the flow of CO₂ transferred from the chamber 11 to the treatment module 200.

As an example, when a predetermined pressure or higher is reached, the valve is opened to ensure the continuous supply of CO₂ to the treatment module 200. When CO₂ flows into the intermediate process of the treatment module 200, the amount of CO₂ to be supplied may be adjusted by adjusting the degree of opening of the valve. Since the cooling and compression capacity is determined to perform operation in response to a predetermined amount to be supplied, the amount of liquid CO₂ recovered to the recovery unit 230 may be reduced when an amount larger than the determined capacity passes through the treatment module 200.

Hereinafter, the specific structure of the treatment module 200 and the path of CO₂ in the treatment module 200 will be described in more detail.

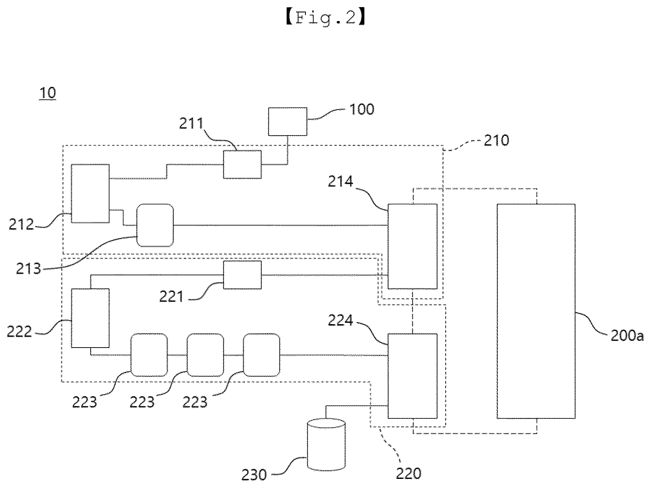

FIG. 2 is a schematic diagram showing the treatment module 200 of the present invention.

Referring to FIG. 2, gaseous CO₂ recovered from the chamber 11 may be provided to the treatment module 200. The treatment module 200 performs compression and cooling. In one embodiment of the present invention, it may include a primary treatment module 210 and a secondary treatment module 220. This performs compression and cooling a plurality of times to ensure that gaseous CO₂ reaches a desired temperature and pressure.

It is obvious that the treatment module 200 may generate a desired environment through one-time compression and cooling so that CO₂ can be liquefied. In contrast, it is designed such that the temperature and pressure can reach target values through a plurality of stages, and, thus, when part of CO₂ recovered to the recovery unit 230 flows in a gaseous state, this can be re-introduced into the primary or secondary treatment module 210 or 220 so that it can be liquefied again. This may lead to more effective cooling and compression by providing CO₂ recovered in the recovery unit 230 to the primary or secondary treatment module 210 or 220 provided in a plurality of stages according to the temperature and pressure of CO₂ recovered in the recovery unit 230.

The basic path through which CO₂ flowing into the treatment module 200 moves will now be described. First, CO₂ provided to the primary treatment module 210 may pass through a first compressor 211, and thus the pressure thereof can be increased. That is, since CO₂ inside the chamber 11 provided by the first compressor 211 corresponds to atmospheric pressure, the pressure of CO₂ may be increased to a first pressure that exceeds at least atmospheric pressure. This refers to a pressure including a positive pressure above atmospheric pressure, and is not limited to atmospheric pressure.

CO₂ in an increased pressure state may be transferred to a first-first cooler 212 and then be cooled. CO₂ provided to the first-first cooler 212 may undergo a slight temperature increase attributable to an increase in density during the process of being compressed through the first compressor 211, but a significant temperature drop exceeding the range of the increased temperature is caused by the first-first cooler 212. Accordingly, it may be in a high-pressure and low-temperature state than CO₂ vaporized in the atmosphere provided to the treatment module 200. Thereafter, in the process in which CO₂ having passed through the first-first cooler 212 is compressed through the first compressor 211 while passing through a first separation unit 213, oil and moisture that may be mixed with CO₂ are removed. CO₂ separated into gas and liquid through the first separation unit 213 may be transferred to the first-second cooler 214 and cooled through the refrigerant. Through this, CO₂ may have the first temperature.

When passing through the first cooling unit, CO₂ passes through the primary treatment module 210 and, thus, can enter a first temperature and first pressure state. CO₂ may then be provided to the secondary treatment module 220. CO₂ provided to the secondary treatment module 220 may pass through the second compressor 221, and the pressure thereof may increase. In other words, CO₂ provided to the second compressor 221 and having passed through the primary treatment module 210 corresponds to the first atmospheric pressure higher than atmospheric pressure, so that the pressure of CO₂ provided by the second compressor 221 is increased to at least the second atmospheric pressure exceeding the first atmospheric pressure. CO₂ in an increased pressure may be transferred to a second-first cooler 222 and then be cooled.

CO₂ provided to the second-first cooler 222 may undergo a slight temperature increase in the process of being compressed through the second compressor 221, but a significant temperature drop exceeding the range of the increased temperature is caused by the second-first cooler 222. Thereafter, in the process in which CO₂ having passed through the second-first cooler 222 is compressed through the second compressor 221 while passing through a second separation unit 223, oil and moisture that may be mixed with CO₂ are removed. CO₂ separated into gas and liquid through the second separation unit 223 may be transferred to the second-second cooler 224 and cooled through the refrigerant. In this case, the second separation unit 223 may selectively perform gas-liquid separation a plurality of times. This may be the process of preventing moisture or oil from being mixed with finally recovered liquid CO₂.

CO₂ having passed through the secondary treatment module 220 may be under the conditions of a second temperature lower than the first temperature and a second pressure higher than the first pressure. It is obvious that it is preferable to liquefy the total amount of CO₂ provided to the treatment module 200 under the second temperature and second pressure through this process. However, gaseous CO₂ for which some conditions are not satisfied may be recovered again and provided to the treatment module 200, so that liquefaction can be attempted again. In connection with this, a description will be given below.

As described above, the treatment module 200 may perform a plurality of cycles. In this example, gaseous CO₂ may be liquefied while sequentially passing through the primary and secondary treatment modules 210 and 220 throughout the plurality of cycles. Each of the cycles may promote the liquefaction of CO₂ by generating a high-pressure and low-temperature environment that lowers the temperature and increases the pressure to liquefy the gas. At least part of CO₂ having passed through the secondary treatment module 220 may be liquefied and collected in a liquid form. The collected liquid CO₂ may be stored in the recovery unit 230 and selectively provided to the chamber 11. It is obvious that the remaining CO₂, excluding some CO₂ that has been liquefied in the process of sequentially passing through the primary and secondary treatment modules 210 and 220, may be provided to the primary or secondary treatment module 210 or 220.

In other words, CO₂ having failed to change the phase thereof into a liquid CO₂ form may be liquefied again by the treatment module 200. In this case, re-attempt may be made possible even when CO₂ is provided to the primary or secondary treatment module 210 or 220 regardless of the conditions of CO2. In order to achieve a purpose more effectively, CO₂ is supplied to either the primary or secondary treatment module 210 or 220 depending on the conditions of CO₂. Accordingly, it may be treated sequentially by the primary treatment module 210 or may be treated by the secondary treatment module 220. In the process of recovering gaseous CO₂ from the recovery unit 230 through a connection means such as a duct connected to the recovery unit 230 and resupplying it to the treatment module 200, whether to supply CO₂ to the primary or secondary treatment module 210 or 220 may be determined by the distribution unit 40.

More specifically, gaseous CO₂ remains in a gaseous state because the temperature and pressure conditions are not satisfied. The gaseous CO₂ may be re-supplied to the treatment module 200 in order to satisfy the above conditions by compensating for specific requirements. At the same time, the state of CO₂ provided to the primary treatment module 210 and the state of CO₂ provided to the secondary treatment module 220 are different from each other, and thus a provision location may be determined by the distribution unit 40.

More specifically, in the extension section of the connection means connecting the distribution unit 40 and the recovery unit 230, a sensor unit 30 including a sensor for detecting one or more of the temperature and pressure of CO₂ is provided, and the sensed information detected by the sensor may be transferred to the distribution unit 40. When it is determined that the information received from the sensing unit satisfies reference information through the comparison of the information received from the sensing unit with the reference information, the distribution unit 40 allows CO₂ to be provided to the secondary treatment module 220. When it is determined that the received information does not satisfy the reference information, CO₂ is provided to the first treatment module 210.

The reference information is information including at least temperature and pressure values. When one or more of the predetermined temperature and pressure values are not satisfied through comparison with the sensed information received from the sensor, it may be classified as falling short of the reference information. When all the information satisfies the reference information, it may be determined that the reference information is satisfied.

CO₂ supplied to the primary treatment module 210 has a lower pressure and a higher temperature than CO₂ supplied to the secondary treatment module 220. These determination criteria may be selectively determined by considering the load of the treatment module 200 and the efficiency of the CO₂ liquefaction process.

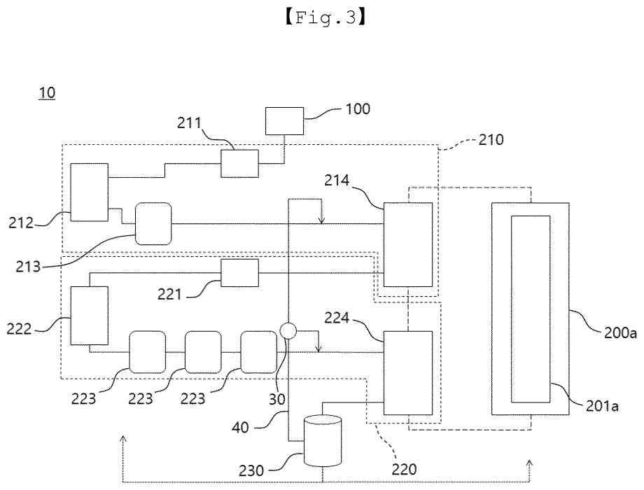

FIG. 3 is a diagram showing a configuration selectively applied to the primary and secondary treatment modules 210 and 220 and a configuration applied to the recovery unit 230 for the purpose of re-cycling and re-cooling in an embodiment of the present invention. The characteristics of each of the configurations will be described with reference to FIG. 3 as follows.

First, a plate heat exchanger may be applied as one or more of the first-second cooler 214 and the second-second cooler 224. In this case, the first-second cooler 214 and the second-second cooler 224 may be designed to be provided adjacent to a refrigerant drive unit 200a, and may also be designed to minimize the section in which the refrigerant moves along a transfer pipe in the process in which the refrigerant circulates. This allows the refrigerant to passes through the section effective for heat exchange (the section including the first-second cooler 214 and the first-second cooler 214) as much as possible, and minimizes the section in which heat exchange does not occur and the refrigerant is re-introduced, thereby providing a circulation path for the refrigerant that flows into the refrigerant drive unit 200a.

In this case, the circulation direction of the refrigerant may be configured such that the refrigerant cooled from the refrigerant drive unit 200a first passes through the second-second cooler 224 and then passes through the first-second cooler 214. As described above, based on the cooling sequence of the refrigerant drive unit 200a, the second-second cooler 224, which is a component that primarily cools CO₂ in a cooling path, needs to perform heat exchange at a lower temperature, so that the cooled refrigerant can exchange heat first. Thereafter, the refrigerant may secondarily cool CO₂ while passing through the first-second cooler 214. Accordingly, the temperature of the refrigerant passing through the second-second cooler 224 may be lower than the temperature of the refrigerant passing through the first-second cooler 214, and the temperature of the CO₂ passing through the second-second cooler 224 may be lower than the temperature of the refrigerant passing through the first-second cooler 214. It is obvious that, as to the temperature between the refrigerant and CO₂ that exchange heat with each other in the first-second cooler 214, the temperature of the refrigerant is formed to be lower, and, as to the temperature between the refrigerant and CO₂ that exchange heat with each other in the second-second cooler 224, the temperature of the refrigerant is also formed to be lower.

Preferably, CO₂ may be lowered to a desired temperature through heat exchange in the second-second cooler 224. For example, the temperature of CO₂ cooled by the first-first cooler 212 may be about 40 degrees, the temperature of the CO₂ cooled by the first-second cooler 214 may be 10 degrees, and the temperature of CO₂ cooled by the second-first cooler 222 may be −10 degrees. Furthermore, the temperature of CO₂ finally cooled by the second-second cooler 224 may be −20 degrees. It is obvious that the temperatures are not limited thereto. However, it is preferable that it gradually decreases through repeated cooling and finally reaches a temperature of −20 degrees or lower.

Second, an air-cooled cooler may be applied as at least one of the first-first cooler 212, the first-second cooler 214, the second-first cooler 222, and the second-second cooler 224, so that the volume of the system 10 can be reduced. Cooling and pressurization are performed repeatedly to satisfy the desired temperature and pressure. When overall cooling is performed by water cooling, the capacity of the refrigerant drive unit 200a needs to be secured, so that the volume of the refrigerant drive unit 200a can be increased. This causes the system 10 to become bulky. Accordingly, at least part of the cooling may be performed through an air-cooled refrigerant condenser. It is obvious that the second-second cooler 224 and the first-second cooler 214, in which active heat exchange is performed, may be water-cooled, but this may be determined in response to the choice of a person skilled in the art. As an example, according to the design, as in the present invention, the first-second cooler 214 and the second-second cooler 224 may be arranged adjacent to one side and connected to the refrigerant drive unit 200a with a refrigerant transfer pipe.

Third, the treatment module 200 may be formed to have a multi-stage configuration. In this case, the multi-stage configuration means that a plurality of modules each including at least a compressor and a cooler are connected in series for the flow of CO₂. In the example of the present invention, the primary and secondary treatment modules 210 and 220 correspond to the multi-stage configuration. By applying the multi-stage treatment module 200, it may be possible to perform excessive changes in temperature and pressure, especially pressure increases, more sequentially while reducing the load on the compressors and the coolers. It is obvious that in this case, the path through which CO₂ moves is extended, but the time for the pressure increase or temperature decrease is reduced in each of the compressors and the coolers. A relatively continuous flow of CO₂ is formed, and thus a predetermined amount of liquefied carbon dioxide LCO₂ per hour can be obtained in the recovery unit 230.

Fourth, the refrigerant drive unit 200a may further include a suction line accumulator 201a. The compression of the refrigerant may be performed by performing heat exchange between the pipe through which the low-pressure refrigerant flows and the pipe through which the high-pressure refrigerant flows, and the compressed, cooled refrigerant may cool CO₂ while sequentially passing through the second-second cooler 224 and the first-second cooler 214. The refrigerant drive unit 200a continuously performs re-cooling while circulating the refrigerant. The accumulator 201a may be included for the purpose of more effective operation in the heat exchange process.

Fifth, although it may be configured in such a manner as to be combined with the blue hydrogen reforming apparatus 100, CO₂ may be continuously accumulated in the chamber 11 during the process of extracting the hydrogen 3 and high-pressure gaseous CO₂ may be periodically released from the chamber 11. That is, only the treatment module 200 may be provided as a separate component that is movable, and CO₂ may be liquefied through selective connection with the chamber 11. As another example, the recovery unit 230 may be selectively combined with the treatment module 200, so that the blue hydrogen reforming apparatus 100 can be continuously operated while replacing the recovery unit 230. That is, one or more of the chamber 11 and the recovery unit 230 of the blue hydrogen reforming apparatus 100 of the present invention may be provided in a form that allows selective combination with the treatment module 200. Furthermore, although CO₂ stored in the recovery unit 230 may be used in a liquefied state for the purpose of cleaning semiconductors and equipment at industrial sites, CO₂ may be provided to the refrigerant drive unit 200a and the treatment module 200 through transfer pipes CL1 and CL2. Accordingly, the individual components are selectively provided through one or more of the first and second transfer pipes CL1 and CL2 as needed and cool one or more of the refrigerant drive unit 200a and the treatment module 200, and thus the more effective driving of the treatment module 200 can be achieved. It is obvious that the main purpose of the system, which is an embodiment of the present invention, is the recovery of liquefied carbon dioxide LCO₂, and the LCO₂ provided to the treatment module and the refrigerant driver may be at least part of the total amount of liquefied carbon dioxide LCO₂ recovered.

When the present invention described above is compared with the conventional technology, the present invention may be similar to the conventional technology in that it is intended to liquefy and use CO₂ generated in the process of extracting hydrogen as a technology related to the production of blue hydrogen. However, blue hydrogen is one of the eco-friendly energies in the spotlight, and green hydrogen is renewable energy that is carbon-free due to the nature of the technology. Accordingly, the present invention should not be compared directly from the perspective of energy efficiency, but should be interpreted from the perspective and effect of reducing the amount of carbon generated during the driving mechanism process.

In other words, when viewed from a broad perspective in which the present invention reduces carbon generated in the process of extracting blue hydrogen, which is eco-friendly energy, and uses collected CO₂ for industrial use, the present invention is characterized in that reuse is enabled in many various fields and immediate reuse is enabled to effectively maintain the driving of the present invention.

In order to implement these characteristics, the present invention includes a structure in which the first transfer pipe and the second transfer pipe are respectively connected to the treatment module and the refrigerant drive unit from the recovery unit that collects liquid CO₂. This has the expected effect of reducing the carbon generated to maintain the cooling of the system by using CO₂ generated in the process of extracting blue hydrogen rather than receiving and using a commonly used refrigerant from the outside. This may be considered to be a technology that reduces the amount of carbon that may be generated from the drive mechanism described above.

Rather than simply considering economic efficiency, the mechanism having this cycle involves the purpose of being equipped with the process of reusing the generated CO₂ to achieve low carbon, more preferably a carbon-free state, to meet the purpose of extracting blue hydrogen, i.e., eco-friendly energy, addressed in the present technical field. The technology for implementing this has been described in detail.

Therefore, increasing the cooling efficiency of the refrigerant drive unit with a refrigerant supplied from the outside for the purpose cooling or using the energy source itself rather than CO₂, i.e., a gas generated in the process of extracting the energy source, is technically completely different from the characteristics sought by the present invention, so that comparison is impossible.

In order to perform the process of the present invention, the present invention is characterized by including the first transfer pipe CL1 and the second transfer pipe CL2 for providing already recovered liquid CO₂ to one or more of the treatment module and the refrigerant drive unit that perform cooling from the recovery unit that has already recovered liquid CO₂ as one of its characteristics.

Therefore, CO₂ is phase-changed into the liquid phase and the gas phase during a heat exchange process in that part of recovered liquid CO₂ is reused, so that rather than making judgments about significant operational effects, interpretation should be made from a more appropriate perspective in evaluating the industrial technology for extracting blue hydrogen, which is eco-friendly energy.

For example, although using conventional fossil fuels directly or using electric energy may ultimately be superior in terms of efficiency and cost, extracting eco-friendly energy such as blue hydrogen should be evaluated from a technology perspective such as the perspective of the eco-friendly purpose, composition and effect, which is a perspective different from the perspectives of existing technologies for using and taking energy. The characteristic of recovering and reusing CO₂ generated in the hydrogen extraction process of the present invention may be considered to be one of the fundamental characteristics included in the present invention.

Although the representative embodiments of the present invention have been described in detail above, those having ordinary skill in the art to which the present invention pertains will appreciate that various modifications may be made to the above-described embodiments without departing from the scope of the present invention. Therefore, the scope of the present invention should not be limited to the described embodiments, but should be defined not only by the claims to be described later but also by equivalents to the claims.

1. A modular system for collecting and liquefying CO₂, the modular system comprising:
a blue hydrogen reforming apparatus configured to extract hydrogen and CO₂ based on natural gas;
a treatment module connected to the blue hydrogen reforming apparatus, and configured to perform predetermined treatment so that pressure of the extracted CO₂ is increased and temperature of the extracted CO₂ is decreased; and
a recovery unit configured to store CO₂ liquefied by the treatment module.

2. he modular system of claim 1, wherein the treatment module performs the decreasing of the temperature through at least a plate heat exchanger.

3. The modular system of claim 1, wherein the treatment module is connected to a suction line accumulator configured to promote cooling.

4. The modular system of claim 1, wherein in the treatment module, at least one of coolers configured to perform the decreasing of the temperature performs cooling through an air cooling-type scheme.

5. The modular system of claim 1, wherein the treatment module performs the increasing of the pressure and the decreasing of the temperature through a plurality of stages.

6. The modular system of claim 1, wherein the treatment module is connected to be selectively separable from the blue hydrogen reforming apparatus and the recovery unit.

7. The modular system of claim 2, wherein:
the treatment module:
is located between the blue hydrogen reforming apparatus and the recovery unit; and
comprises primary and secondary treatment modules configured such that CO₂ sequentially passes therethrough; and
the primary treatment module comprises a first compressor, a first-first cooler, a first separation unit and a first-second cooler through which CO₂ sequentially moves, and the secondary treatment module comprises a second compressor, a second-first cooler, one or more second separation units and a second-second cooler through which CO₂ sequentially moves.

8. The modular system of claim 7, wherein:
the blue hydrogen reforming apparatus comprises a chamber configured to maintain internal pressure above atmospheric pressure and store CO₂; and
the chamber comprises a valve configured to be opened only in one direction, which is a direction in which CO₂ flows in, on one side and to be selectively opened in a direction in which CO₂ is provided to the treatment module on a remaining side.

9. The modular system of claim 8, further comprising a refrigerant drive unit configured to provide a refrigerant to exchange heat with the first-second cooler and the second-second cooler, wherein the refrigerant drive unit provides the refrigerant so that the refrigerant sequentially passes through the second-second cooler and the first-second cooler and cools the refrigerant when it is re-introduced.

10. The modular system of claim 9, further comprising:
a distribution unit configured to transfer CO₂, introduced in a gaseous state out of CO₂ stored in the recovery unit, to one of the first and second treatment modules; and
a sensor unit located in an extension section of the distribution unit, and configured to guide CO₂ so that CO₂ can be transferred to one of the first and second treatment modules through comparison between sensing information obtained by detecting temperature and pressure of CO₂ in a gaseous state and predetermined sensing information.

11. The modular system of claim 10, wherein at least part of CO₂ liquefied and stored in the recovery unit is supplied to one or more of the primary and secondary treatment modules, and is cooled by heat exchange with the CO₂ in the gaseous state, or is provided to the refrigerant drive unit, and cools the refrigerant.

12. The modular system of claim 3, wherein:
the treatment module:
is located between the blue hydrogen reforming apparatus and the recovery unit; and
comprises primary and secondary treatment modules configured such that CO₂ sequentially passes therethrough; and
the primary treatment module comprises a first compressor, a first-first cooler, a first separation unit and a first-second cooler through which CO₂ sequentially moves, and the secondary treatment module comprises a second compressor, a second-first cooler, one or more second separation units and a second-second cooler through which CO₂ sequentially moves.

13. The modular system of claim 4, wherein:
the treatment module:
is located between the blue hydrogen reforming apparatus and the recovery unit; and
comprises primary and secondary treatment modules configured such that CO₂ sequentially passes therethrough; and
the primary treatment module comprises a first compressor, a first-first cooler, a first separation unit and a first-second cooler through which CO₂ sequentially moves, and the secondary treatment module comprises a second compressor, a second-first cooler, one or more second separation units and a second-second cooler through which CO₂ sequentially moves.

14. The modular system of claim 5, wherein:
the treatment module:
is located between the blue hydrogen reforming apparatus and the recovery unit; and
comprises primary and secondary treatment modules configured such that CO₂ sequentially passes therethrough; and
the primary treatment module comprises a first compressor, a first-first cooler, a first separation unit and a first-second cooler through which CO₂ sequentially moves, and the secondary treatment module comprises a second compressor, a second-first cooler, one or more second separation units and a second-second cooler through which CO₂ sequentially moves.

15. The modular system of claim 6, wherein:
the treatment module:
is located between the blue hydrogen reforming apparatus and the recovery unit; and
comprises primary and secondary treatment modules configured such that CO₂ sequentially passes therethrough; and
the primary treatment module comprises a first compressor, a first-first cooler, a first separation unit and a first-second cooler through which CO₂ sequentially moves, and the secondary treatment module comprises a second compressor, a second-first cooler, one or more second separation units and a second-second cooler through which CO₂ sequentially moves.
